(19) United States
(12) Patent Application Publication
(10) Pub. No.: US 2013/0128296 A1
(43) Pub. Date: May 23, 2013

(54) PRINTING APPARATUS, METHOD AND PROGRAM

(71) Applicant: CANON KABUSHIKI KAISHA, Tokyo (JP)

(72) Inventor: Yasuhiro Takahashi, Kawasaki-shi (JP)

(73) Assignee: CANON KABUSHIKI KAISHA, Tokyo (JP)

(21) Appl. No.: 13/658,280

(22) Filed: Oct. 23, 2012

(30) Foreign Application Priority Data
Nov. 17, 2011 (JP) 2011-251886

(51) Int. Cl. G06K 15/02

(52) U.S. Cl. 358/1.13

(57) ABSTRACT

There are provided a printing apparatus, and a control method and a program thereof which, in a case of box-storing a password document, can in advance avoid occurrence of a state where the password document can not be printed depending upon the setting of the printing apparatus. In a case of box-storing a password document, a user is notified at the box-storing that there is a possibility of occurrence of a state where the password document can not be printed depending upon the setting of a printing apparatus.

### BACKGROUND OF THE INVENTION

1. Field of the Invention

The present invention relates to a printing apparatus, method and program, which deal with a document on which password information is printed.

2. Description of the Related Art

Japanese Patent Laid-Open No. 2009-017303 discloses a technique of combining a code image including copy prohibition information with a document image including confidential information for printing. When a user places a printed matter (copy prohibition document) on a document table of a copier to provide an instruction of a copy processing start, the copier scans the printed matter, finds the code image including the copy prohibition information from the scanned image, and cancels the copy process.

In addition, Japanese Patent Laid-Open No. 2009-017303 discloses a technique of combining a code image including copy prohibition information with a document image including confidential information for printing. When a user places a printed matter (password document) on a document table of a copier to provide an instruction of a copy processing start, the copier scans the printed matter, finds the code image including the password information from the scanned image, and interrupts the copy process. In addition, the copier makes an input request of a password to the user. In a case where the user inputs the correct password, the copy process is restarted to produce the copy document. That is, the copier prints the scanned image.

Further, according to Japanese Patent Laid-Open No. 2009-017303, when the password document is placed on the document table in the copier to provide an instruction of the copy processing start in a state where the setting of combining the code image including the password information is made, the copier scans the password document. When the copier finds the code image including the password information from the scanned image, the copy process is cancelled. The reason for the cancellation is to prevent degradation in security. That is, when a plurality of the code images are overlapped on a single document to be combined thereon, it is hard for the copier to find any of the code images and the copying can be made without input of the password information. Therefore the cancellation is performed to prevent such a copy document from being produced.

However, Japanese Patent Laid-Open No. 2009-017303 discloses simply the copy process, and does not disclose box storing (storing process), as well as a printing process accompanying the storing process. The box storing means a process of scanning a document to store the scanned image in a memory device such as an HDD or a memory. The printing process accompanying the storing process means a process of, in a case where a printing instruction for the scanned image stored in the memory device is provided from a user, printing the scanned image.

The problem occurring at the time of printing the scanned image will be in more detail explained. It is assumed that the print setting of combining the code image including the password information with the scanned image is provided in the copier. In addition, it is assumed that, on a condition that this print setting is provided, the copier scans the password document. In this case, when a user provides an instruction of the box storing, the scanned image will be stored in the memory device without any problem. This is because the storing process has no relationship with the print setting.

However, when the user provides an instruction of printing the scanned image stored in the memory device after several days have passed, the copier has to cancel the printing process.

Here, if the user can release the print setting of combining the above code image, there occurs no problem. However, in a case where the print setting is forced to be implemented (that is, in a case where the print setting is provided by an administrator in such a manner as to be applied to all the scanned images), there occurs the event that although the scanned image is stored in the memory device, the printing can not be performed.

### SUMMARY OF THE INVENTION

A printing apparatus according to the present invention includes a printing apparatus capable of printing a scanned image stored therein, comprises: a scanning unit configured to scan a document in response to an instruction of storing the scanned image by a user; a first determining unit configured to determine whether or not an administrator setting of combining a code image including password information with the scanned image is made; a second determining unit configured to determine whether or not the code image including the password information is included in a scanned image obtained through a scanning by the scanning unit; and a notifying unit configured to, in a case where it is determined by the first determining unit that the administrator setting of combining the code image including password information with the scanned image is made and by the second determining unit that the code image including the password information is included in the scanned image obtained through the scanning by the scanning unit, give a notice regarding the storing of the scanned image obtained through the scanning by the scanning unit to the user.

According to the present invention, in a case of box-storing the password document, the user is notified at the box-storing time that there is a possibility of occurrence of a state where the password document can not be printed depending on the setting in the printing apparatus. This notification prevents the wasteful box storing from being performed.

Further features of the present invention will become apparent from the following description of exemplary embodiments (with reference to the attached drawings).

### BRIEF DESCRIPTION OF THE DRAWINGS

FIG. 1 is a block diagram showing the hardware structure of a printing apparatus;

FIGS. 2A and 2B are diagrams showing a document where password information is not embedded and a document where the password information is embedded;

FIG. 3 is a block diagram showing the software structure of the printing apparatus;

FIG. 4 is a flow chart showing a flow of a process of the printing apparatus in a case of performing box storing;

FIG. 5 is an example of a screen for causing a user to select whether the box storing continues to be performed or is cancelled;

FIG. 6 is an example of a screen for receiving password input from the user;

FIG. 7 is an example of a selection screen of box documents;

FIG. 8 is a flow chart showing a flow of a process of the printing apparatus in a case of performing box printing;

FIG. 9 is a diagram showing the relationship of FIGS. 9A and 9B;

FIGS. 9A and 9B are a flow chart showing a flow of a process of the printing apparatus in a case of performing box storing; and

FIG. 10 is a flow chart showing a flow of a process of the printing apparatus in a case of performing box printing.

### DESCRIPTION OF THE EMBODIMENTS

Hereinafter, embodiments according to the present invention will be in detail explained with reference to the accompanying drawings. It should be noted that components described in the embodiments are adopted absolutely as an example, and the scope of the present invention is not limited to those.

### Embodiment 1

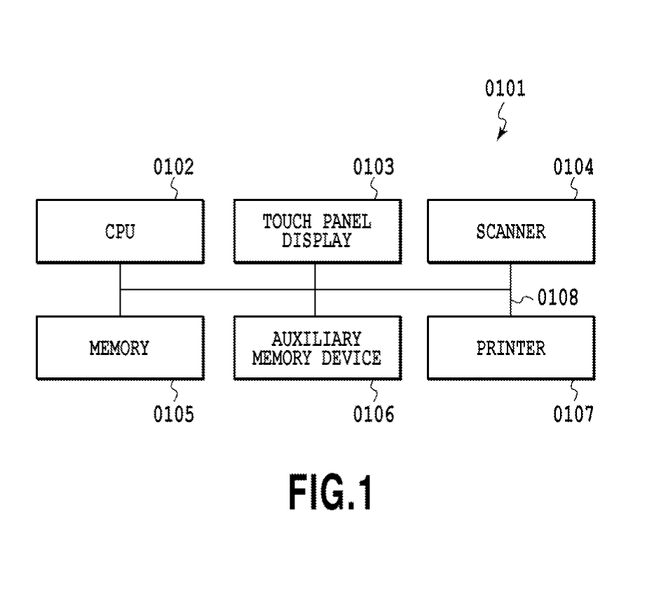

FIG. 1 is a diagram showing the hardware structure of a system according to Embodiment 1 in the present invention. A printing apparatus 0101 is structured of a central processor unit (hereinafter, CPU) 0102, a touch panel display 0103, a scanner 0104, a printer 0107, a memory 0105, and an auxiliary memory device 0106. These components are respectively connected to an internal bus 0107.

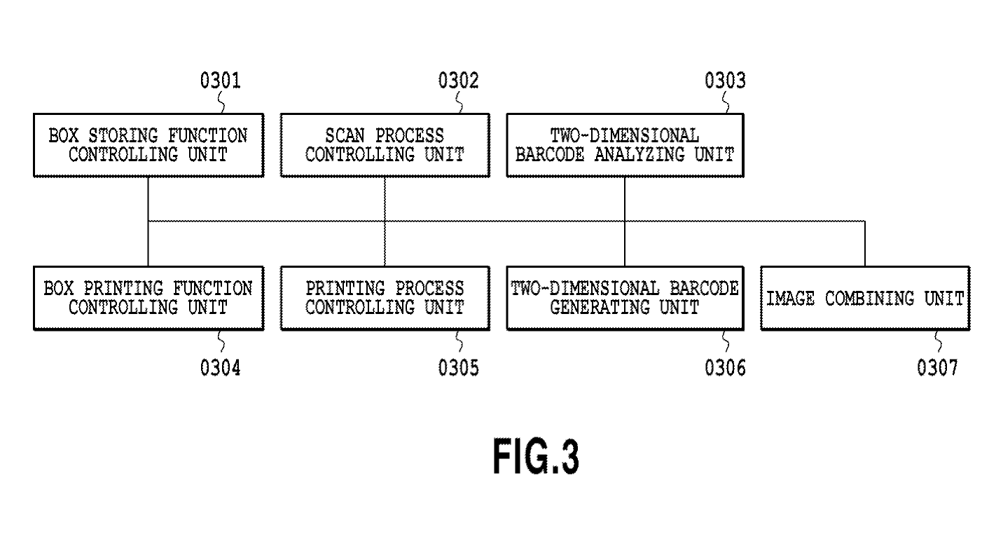

The CPU 0102 executes programs developed in the memory 0105 and performs controls of various devices. The touch panel display 0103 provides information to a user by a display, and receives key input from the user. That is, the touch panel display 0103 functions as a display component, an operational component or an input component. The scanner 0104 emits an image on a document by a light source and images the reflective image on a solid-state sensing device by a lens. The solid-state sensing device generates an image-reading signal with a predetermined resolution (for example, 600 dpi) and a predetermined concentration level (for example, 8 bits), and structures a scanned image composed of raster data from the image-reading signal. The printer 0107 prints the scanned image developed on the memory 0105 on a print paper. The memory 0105 serves as a development location of programs to be executed by the CPU 0102, and can retain data to be used in the program. The auxiliary memory device 0106 is structured of a memory device of a large capacity such as a hard disc drive, and stores scanned image data therein. In addition, the auxiliary memory device 0106 also stores various data such as application programs to be executed by the printing apparatus 0101. These application programs are developed in the memory 0105 by the CPU 0102 for execution, and thereby the CPU 0102 can be operated as each unit shown in FIG. 3.

### <Box Storing Process>

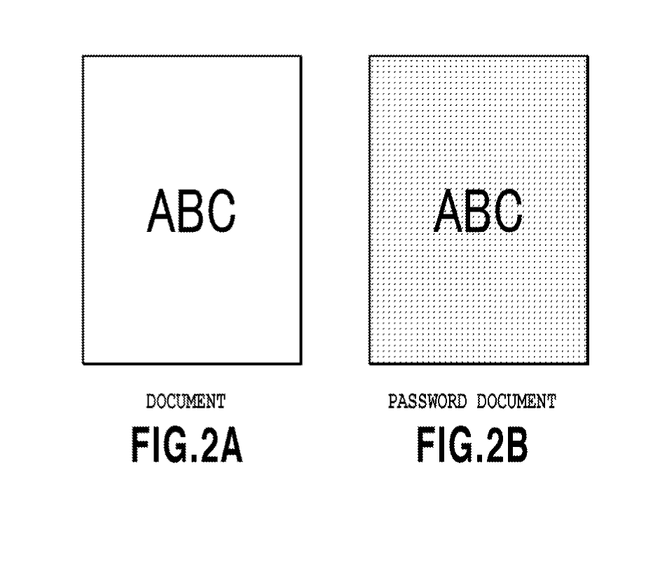

Next, the box storing process to two kinds of documents shown in FIG. 2 will be explained with reference to FIG. 3 to FIG. 6.

FIG. 2A shows a document where a code image including password information is not printed, and FIG. 2B shows a document (password document) where a code image including password information is printed. Here, the code image means an image such as a barcode, a two-dimensional barcode or digital electronic watermark, and is an image including information which humans can not read, but machines can read. In the present embodiment, the two-dimensional barcode will be exemplified as the code image and the flow chart also will be explained based upon the two-dimensional barcode. However, without mentioning, the process shown in each flow chart in the present embodiment is not limited to the two-dimensional barcode, and can be applied to the other code image.

The box storing is a function of temporarily storing the scanned image obtained by the scanner 0104 in the auxiliary memory device 0106. The scanned image stored by the box storing can be printed on a print paper by the printer 0107 according to a print instruction of a user. This is called box printing.

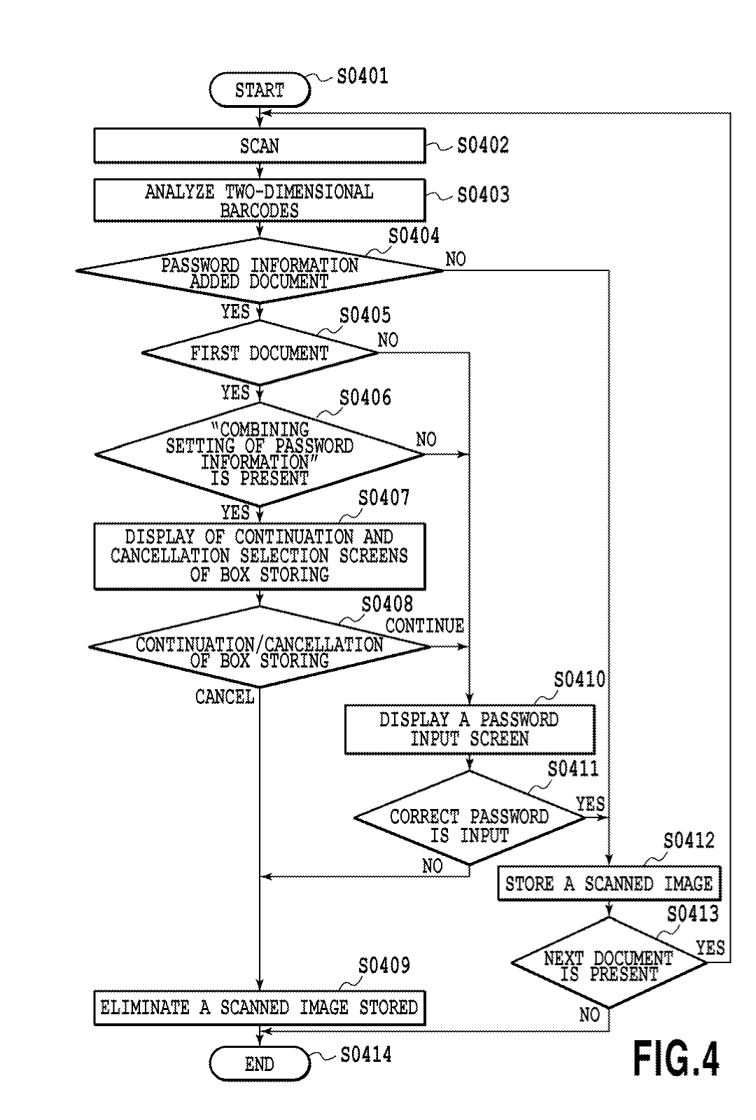

FIG. 3 is a block diagram showing the software structure of the printing apparatus 0101. FIG. 4 is a flow chart showing a flow of the box storing process by the printing apparatus 0101.

The printing apparatus 0101, when a user selects the box storing function displayed on the touch panel display 0103 and pushes down a scan start button, starts with the box storing process by a box storing function controlling unit 0301 (step S0401).

At step S0402, the box storing function controlling unit 0301 scans a document with the scanner 0104 by a scan process controlling unit 0302 in response to a storing instruction of the scanned image by the user, and stores the scanned image in the memory 0105.

At step S0403, a two-dimensional barcode analyzing unit 0303 analyzes the scanned image to determine whether or not a two-dimensional barcode including password information is embedded. In addition, as described above, the code image to be analyzed is not limited to the two-dimensional barcode, and may be the other code image such as a barcode or digital electronic watermark as long as the password information is therein included. The same can be applied to embodiments to be described later.

At step S0404, the next process is determined corresponding to the result of the previous two-dimensional barcode analyzing unit 0303. In a case where the two-dimensional barcode including the password information is embedded in the scanned image (in a case of a document in FIG. 2B), the process goes to step S0405, and in a case where the password is not embedded in the scanned document (in a case of a document in FIG. 2A), the process goes to step S0412.

At step S0405, the box storing function controlling unit 0301 determines whether or not the scanned image is an image of the first document. In a case where the scanned image is the image of the first document, the process goes to step S0406. In a case where the scanned image is the image of the second document or the following documents, the process goes to step S0410, so that each process of step S0406 to step S0408 is not repeatedly executed to the image of the second document or the following documents.

At step S0406, the box storing function controlling unit 0301 determines at box printing whether or not an administrator setting of combining the two-dimensional barcode including the password information with the scanned image is made to the printing apparatus 0101. Here, this setting is estimated to be made by an administrator of the printing apparatus 0101 to be applied to all the scanned images and be incapable of being altered by a general user. As described above, the code image to be combined is not limited to the two-dimensional barcode, and may be the other code image such as a barcode or digital electronic watermark as long as the password information is therein included. The same can be applied to embodiments to be described later. The details of a box printing operation will be explained later.

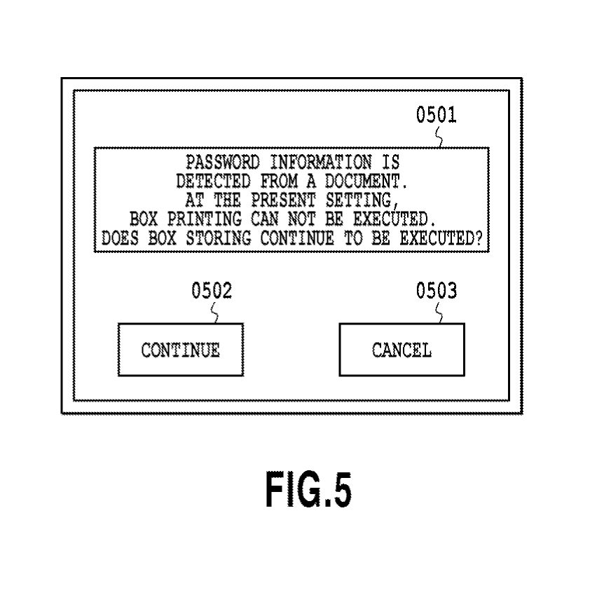

In a case where it is determined that the combining setting of the password information is made, the process goes to step S0407, wherein a screen as shown in FIG. 5 is displayed on the touch panel display 0103. On the screen shown in FIG. 5, there are arranged words for prompting a user to pay attention (0501), and box buttons for determining continuation (0502) or cancellation (0503) of the box storing process.

That is, in a case where it is determined that the password information is included in the scanned image (S0404:Yes) and the setting of combining the password information with the scanned image is made (S0406:Yes), the notice is given to a user by the screen shown in FIG. 5. This notice, as shown in an example of FIG. 5, indicates the information that the scanned image obtained by the scanning can be stored, but the stored scanned image can not be printed. Through this notice, in a case of box-storing the password document, the user can recognize that there is a possibility that there occurs a state where the password document can not be printed depending upon the setting of the printing apparatus, and therefore the execution of the wasteful box storing can be prevented.

It should be noted that the content of this notice is not limited to the example shown in FIG. 5, and is only required to be the content by which a user can recognize that there is a possibility that there occurs a state where the password document can not be printed. For example, this may be the notice that it is possible to store the scanned image obtained by the scanning, but it is impossible to print the stored scanned image unless the administrator setting is released. In addition, the event that the scanned image obtained by the scanning is not stored or is eliminated, can be notified.

Further, as shown in FIG. 5, the inquiry notice on whether to store the scanned image obtained by the scanning can be made. Since buttons on whether the box storing process continues to be executed (0502) or is cancelled (0503) are arranged on the notice screen, a user can select either the box storing process of the scanned image continues to be executed or is cancelled. The printing apparatus 0101 continues the execution of or cancels the storing process of the scanned image in response to an instruction (selection) of the user.

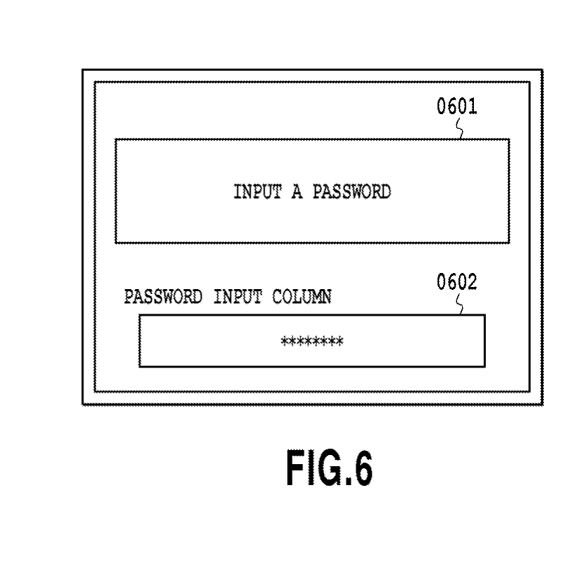

Next, at step S0408 in a case where the touch panel display 0103 detects that the continuation button (0502) is pushed down by the user, the process goes to step S0410, wherein a screen shown in FIG. 6 is displayed on the touch panel display 0103.

Words for prompting the user to perform password input (0601) and a password input column (0602) for receiving password input from the user are arranged on the screen shown in FIG. 6.

At step S0411, in a case where the box storing function controlling unit 0301 determines that the password input by the user is correct, the process goes to step S0412. It should be noted that it is not necessary to execute step S0410 and step S0411 in all the documents, and in a case where it is determined that the same password information as that of a document immediately before the present document is added, the process may be omitted estimating that the correct password is already input by the user.

At step S0412, the scanned image is stored as the box document in the auxiliary memory device 0106, and the process goes to step S0413.

At step S0413, it is determined whether or not the next document is present. In a case where the next document is present, the process goes back to step S0402. In a case where the next document is not present, the box storing process ends (step S0414).

On the other hand, in a case where at step S0408 it is determined that the cancellation button (0503) is pushed down by the user, or in a case where at step S0411 it is determined that the password input by the user is incorrect, the process goes to step S0409. At step S0409, the scanned image to the previous document already stored in the auxiliary memory device 0106 is eliminated, and the box storing process ends.

In the present embodiment, in a case where the password information is included in the scanned image (S0404:Yes) and the setting of combining the password information with the scanned image is made (S0406:Yes), the notice is given to the user. However, the present embodiment is not limited to this example. The box storing process may be cancelled without confirmation of a user's intent in regard to the continuation of the box storing process by this notice. By doing so, it can be certainly prevented that the box storing process is executed to the password document which can not be printed.

As described above, according to the box storing process in the present embodiment, in a case where the password information is included in the scanned image and the administrator setting of combining the password information with the scanned image is made, the notice is given to the user or the box storing process is cancelled. As a result, in a case of box-storing the password document, the user can recognize that there is a possibility that there occurs a state where the password document can not be printed depending upon the setting of the printing apparatus, and the wasteful box storing can be prevented to be performed.

### <Box Printing Process>

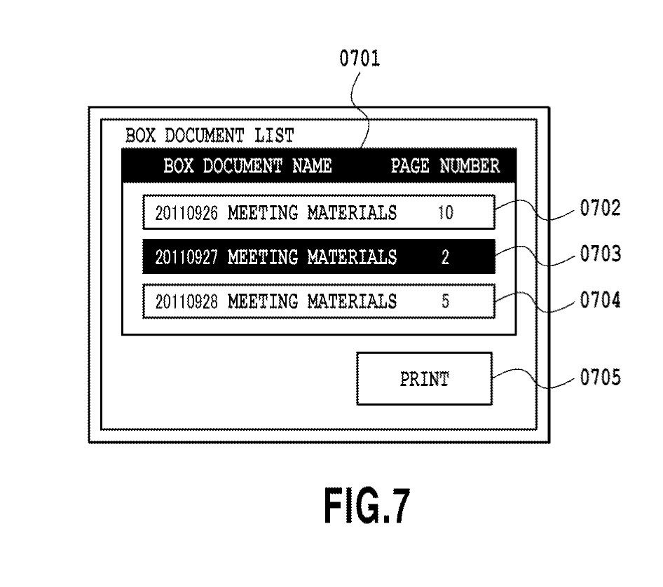

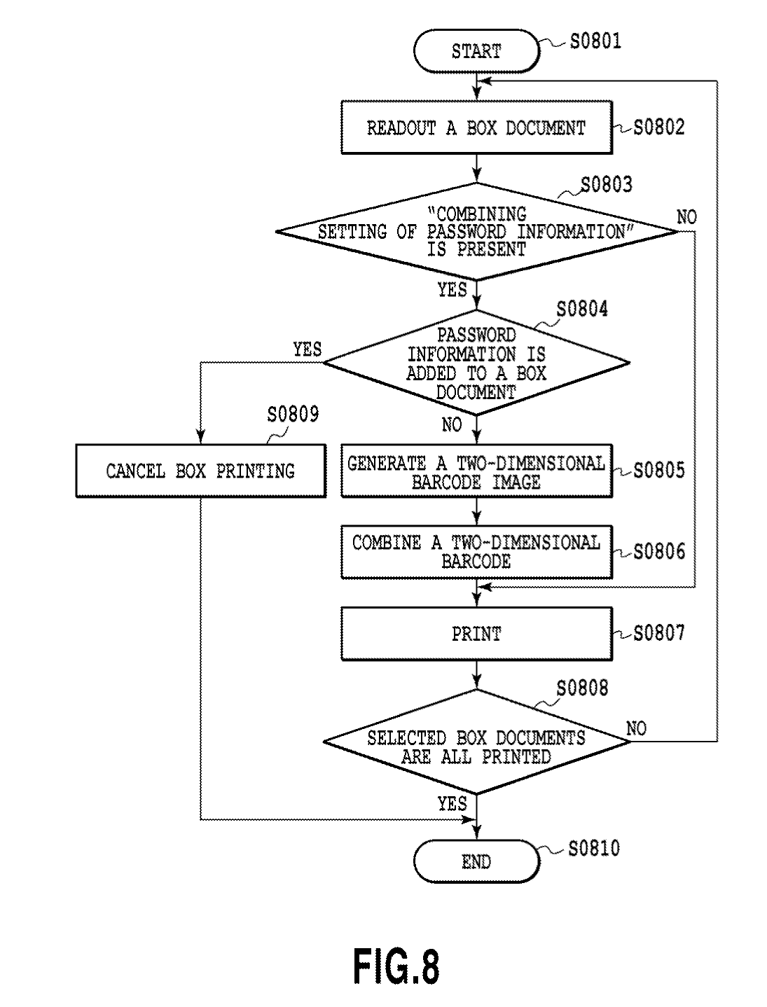

Next, the box printing process will be explained with reference to FIG. 3, FIG. 7 and FIG. 8. FIG. 7 shows an example in which a list of box documents as the scanned image box-stored by the aforementioned process is displayed on the touch panel display 0103. FIG. 8 is a flow chart showing a flow of the box printing process by the printing apparatus 0101.

A list of the box documents 0701 is displayed in the touch panel display 0103, which indicates that three box documents (0702, 0703 and 0704) are stored. The box document 0703 is reversed in display, which indicates a state where this document is selected by the user.

When the touch panel display 0103 detects that the button (0705) for printing is pushed down by the user in this state,
the box printing process is started by the box printing function controlling unit 0304 (step S0801).

The box printing function controlling unit 0304 reads out the box document selected by the user at step S0802, on the memory 0105 from the auxiliary memory device 0106.

At step S0803, the box printing function controlling unit 0304 determines whether or not the setting of combining the two-dimensional barcode including the password information with the box document is made to the printing apparatus 0101.

In a case where the setting of combining the two-dimensional barcode including the password information is made, the process goes to step S0804, wherein the box printing function controlling unit 0304 determines whether or not the password information is added to the box document read out on the memory 0105. In a case where the password information is not added to the box document, the process goes to step S0805.

At step S0805, a two-dimensional barcode is generated according to the combining setting of the password information preset, by a two-dimensional barcode generating unit 0306. It should be noted that the two-dimensional barcode to be generated herein may be a character row of the password itself or may be shown by using a hash value of the password.

At step S0806, the two-dimensional barcode generated at step S0805 and the box document read out on the memory 0105 at step S0802 are combined by an image combining unit 0307.

At step S0807, the combined document is printed by a printing process controlling unit 0305. At step S0808, the box printing function controlling unit 0304 determines whether or not the documents selected are all printed. In a case where the box document not yet printed is present, the process goes back to step S0802. In a case where all the documents are printed, the box printing process ends (step S0810).

On the other hand, in a case where at step S0804 it is determined that the password information is added to the box document, the process goes to step S0809. At step S0809, the box printing process is cancelled, and all the processes end (step S0810).

### Embodiment 2

In Embodiment 1, the box storing/box printing process to the password document is described. In Embodiment 2, the box storing/box printing process to a copy prohibition document and a copy permission document will be explained in addition to the password document. The copy prohibition document literally means a document which can not be copied. The copy permission document means a document which can be copied. Each of them is a document on which the information of controlling a copy operation of “copy prohibition” or “copy permission” is printed as a code image.

The present embodiment will be explained based upon an example using the two-dimensional barcode as the code image, but the present embodiment is not limited thereto. The present embodiment can be applied to the other code image such as digital electronic watermark, which is the same as Embodiment 1. In addition, in the present embodiment, the control information showing the password document, the copy prohibition document or the copy permission document for controlling a copy operation is collectively called copy control information.

### <Box Storing Process>

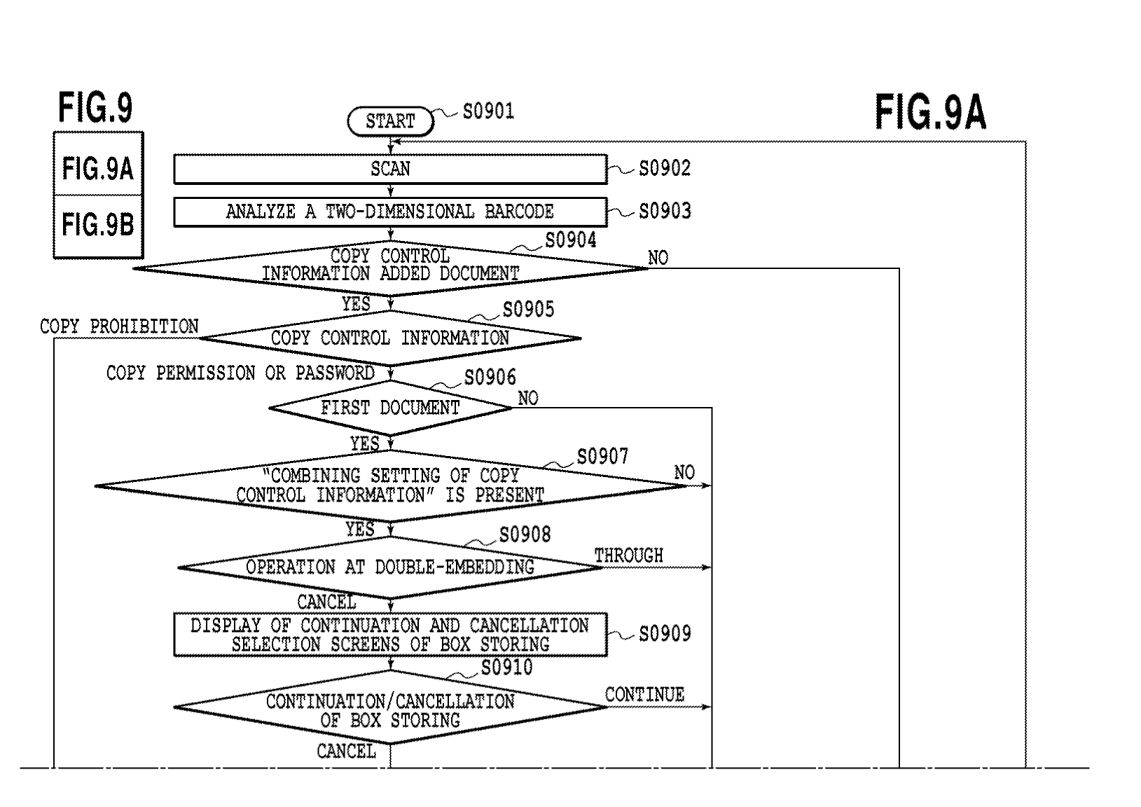

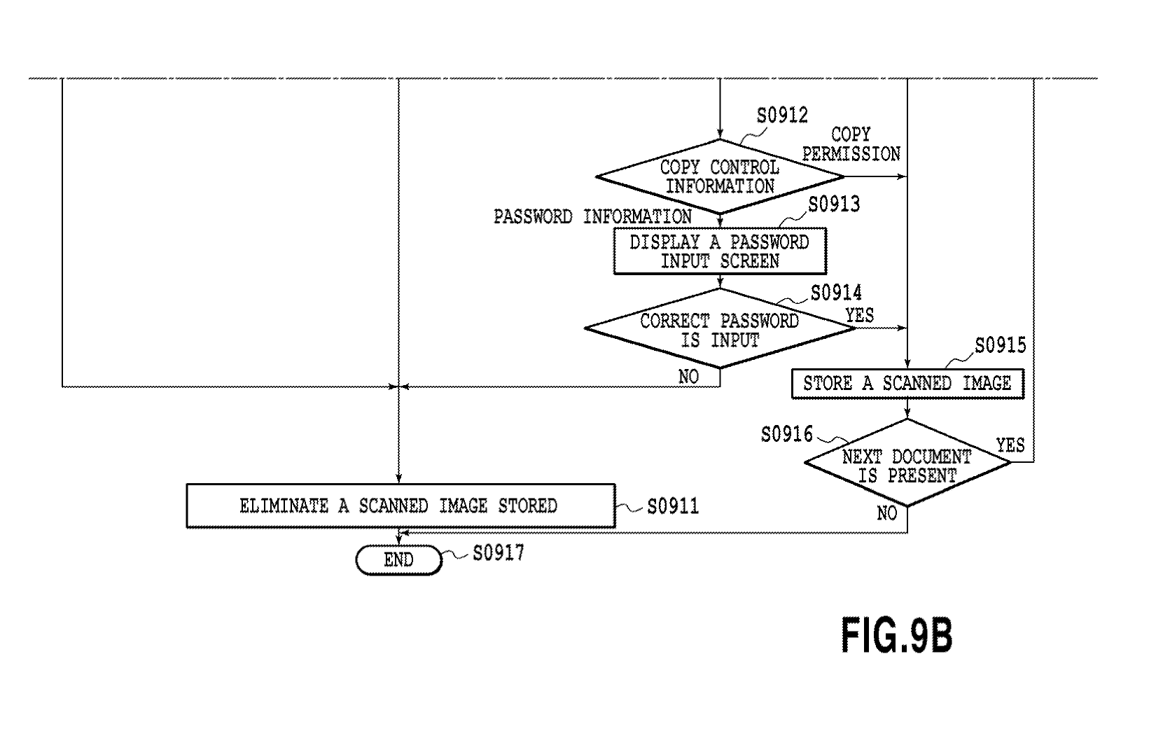

The box storing process to each of a document on which copy control information is not printed and a document on which copy control information is printed will be explained with reference to FIG. 3, FIG. 5, FIG. 6, FIG. 9A and FIG. 9B.

The printing apparatus 0101, when a user selects the box storing function displayed on the touch panel display 0103 and pushes down the scan start button, starts the box storing process by the box storing function controlling unit 0301 (step S0901).

At step S0902, the box storing function controlling unit 0301 scans a document by the scanner 0104 by the scan process controlling unit 0302 in response to a storing instruction of the scanned image by the user, and stores the scanned image in the memory 0105.

At step S0903, the scanned image is analyzed by the two-dimensional barcode analyzing unit 0303 to determine whether or not a two-dimensional barcode including the copy control information is embedded.

At step S0904, the next process is determined corresponding to the result of the previous two-dimensional barcode analyzing unit 0303. In a case where the two-dimensional barcode including the copy control information is embedded in the scanned image, the process goes to step S0905, and in a case where the copy control information is not embedded in the scanned document, the process goes to step S0915.

At step S0905, further the next process is determined corresponding to the content of the copy control information. In a case where the copy control information indicates a copy prohibition document, the process goes to step S0911. In a case where the copy control information indicates a copy permission document or a password document, the process goes to step S0906.

At step S0906, the box storing function controlling unit 0301 determines whether or not the scanned image is an image of the first document. In a case where the scanned image is the image of the first document, the process goes to step S0907. In a case where the scanned image is the image of the second document or the following documents, the process goes to step S0912, so that each process of step S0907 to step S0910 is not repeatedly executed to the image of the second document or the following documents.

At step S0907, the box storing function controlling unit 0301 determines at box printing whether or not an administrator setting of combining the copy control information with the scanned image as the two-dimensional barcode is made to the printing apparatus 0101. The details of the box printing operation will be explained later. In a case where it is determined that the printing apparatus 0101 is set in such a manner as to combine the copy control information, the process goes to step S0908.

In a case where at step S0905 it is determined that the copy control information shows the copy permission document or the password document and at step S0907 it is determined that the setting of combining the copy control information is made, the copy control information is further combined with the scanned image to which the copy control information has been added. Here, the copy control information is further combined with the scanned image to which the copy control information has been added, which is called double embedment.

At step S0908, the following process is switched depending upon the setting of the box printing process in a case where combining the copy control information becomes the double embedment.

Specifically when the box printing process becomes the double embedment, the process goes to step S0909 in a case where the setting of cancelling the box printing process (printing) is made. In addition, when the box printing process becomes the double embedment, the process goes to step S0912 in a case where the setting of continuing the box printing process ignoring the print setting of combining the copy control information (without combining the copy control information) is made.

The setting content of the box printing process when the box printing process becomes the double embedment is in advance stored in a memory component in the printing apparatus 0101. It should be noted that the details of the box printing operation will be described later.

At step S0909, the screen as shown in FIG. 5 is displayed on the touch panel display 0103. On the screen shown in FIG. 5, there are arranged words for prompting a user to pay attention (0501), and box buttons for determining continuation (0502) or cancellation (0503) of the box storing process.

That is, at step S0908 it is determined whether or not the notice to a user (step S0909) is made, depending upon the setting of the process at the double-embedding of the copy control information set in the printing apparatus 0101. This notice shows that although it is possible to store the scanned image obtained by the scanning, it is impossible to print the scanned image stored. Further, the user having receiving this notice can select either continuation or cancellation of the storing process.

In a case where at step S0910 the touch panel display 0103 detects that the continuation button (0502) is pushed down by the user, the process goes to step S0912.

At step S0912 the next process is determined corresponding to the content (password document or copy permission document) of the copy control information added to the scanned document. In a case where the copy controlling document is the password document, the process goes to step S0913, and in a case where the copy controlling document is the copy permission document, the process goes to step S0915.

At step S0913, the screen as shown in FIG. 6 is displayed on the touch panel display 0103. On the screen shown in FIG. 6, there are arranged words for prompting the user to perform password input (0601) and a password input column (0602) for receiving password input from the user.

At step S0914, in a case where the box storing function controlling unit 0301 determines that the password input by the user is correct, the process goes to step S0915. It should be noted that it is not necessary to execute step S0913 and step S0914 in all the documents, and in a case where it is determined that the same password information as that of a document immediately before the present document is added, the process may be omitted estimating that the correct password is already input by the user.

At step S0915, the scanned image is stored as the box document in the auxiliary memory device 0106, and the process goes to step S0916. At step S0916, it is determined whether or not the next document is present. In a case where the next document is present, the process goes back to step S0902. In a case where the next document is not present, the box storing process ends (step S0917).

On the other hand, in a case where at step S0910 it is determined that the cancellation button (0503) is pushed down by the user, or in a case where at step S0914 it is determined that the password input by the user is incorrect, the process goes to step S0911. At step S0911, the scanned image to the previous document already stored in the auxiliary memory device 0106 is eliminated, and the box storing process ends (step S0917).

As described above, according to the present embodiment, in a case where the scanned image is an image obtained by scanning the password document or the copy permission document and the administrator setting of combining the copy control information with the scanned image is made, the notice is given to the user or the box storing process continues to be executed.

In addition, in a case where the box storing process continues to be executed, the double embedment of the copy control information is not performed in the box printing process as described later. As a result, in a case of box-storing the scanned document of the password document or the copy permission document, it is possible to avoid occurrence of a state where the scanned document can not be printed, and the wasteful box storing can be prevented to be executed.

### <Box Printing Process>

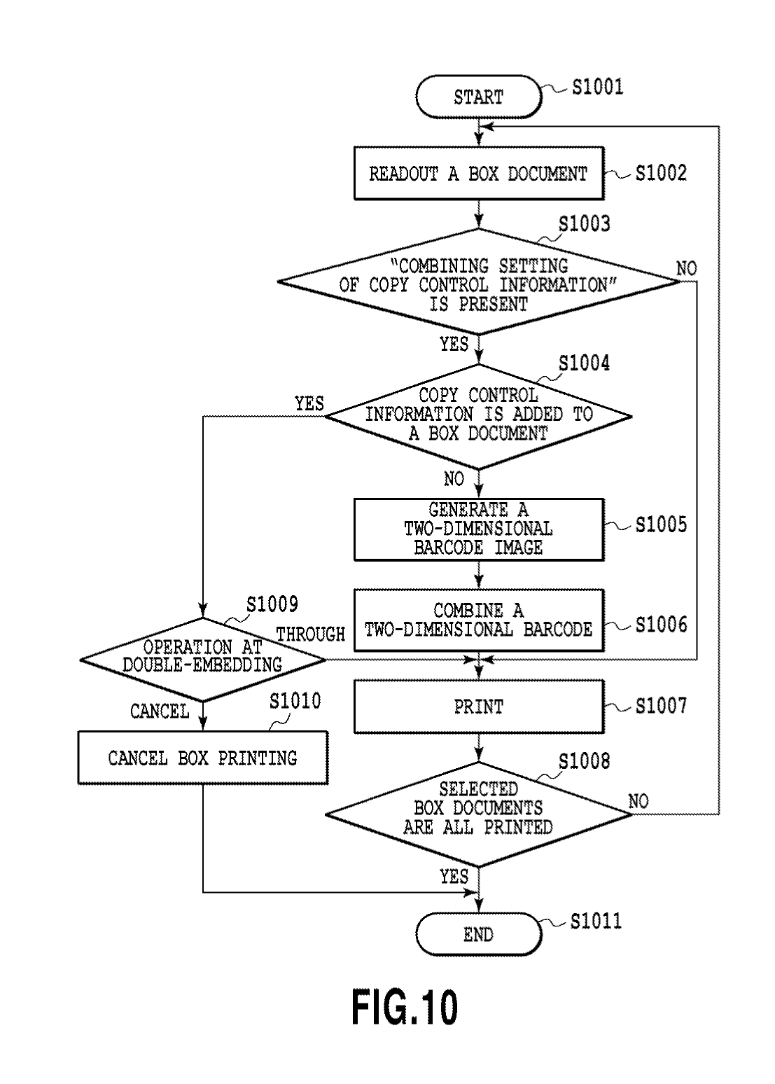

Next, the box printing process will be explained with reference to FIG. 3, FIG. 7 and FIG. 10. FIG. 7 shows an example in which a list of box documents as the scanned image box-stored by the aforementioned process is displayed on the touch panel display 0103. FIG. 10 is a flow chart showing a flow of the box printing process by the printing apparatus 0101.

When the touch panel display 0103 detects that the button 0705 for printing is pushed down by the user in a state of selecting the box document 0703, the box printing process is started by the box printing function controlling unit 0304 (step S1001).

The box printing function controlling unit 0304 reads out the box document selected by the user at step S1002, on the memory 0105 from the auxiliary memory device 0106.

At step S1003, the box printing function controlling unit 0304 determines whether or not the setting of combining the copy control information with the box document as the two-dimensional barcode is made to the printing apparatus 0101.

In a case where the setting of combining the copy control information as the two-dimensional barcode is made, the process goes to step S1004, wherein the box printing function controlling unit 0304 determines whether or not the copy control information is added to the box document read out on the memory 0105. In a case where the copy control information is not added to the box document, the process goes to step S1005.

At step S1005, a two-dimensional barcode is generated according to the combining setting of the copy control information preset, by the two-dimensional barcode generating unit 0306. At step S1006, the two-dimensional barcode generated at step S1005 and the box document read out on the memory 0105 at step S1002 are combined by the image combining unit 0307.

At step S1007, the combined document is printed by the printing process controlling unit 0305. At step S1008, the box printing function controlling unit 0304 determines whether or not the documents selected are all printed. In a case where the box document not yet printed is present, the process goes back to step S1002. In a case where all the documents are printed, the box printing process ends (step S1011).

On the other hand, in a case where at step S1004 it is determined that the copy control information is added to the box document, the process goes to step S1009. At step S1009, the next process is determined depending upon the operation setting of the box printing in advance set in the printing apparatus 0101.

To the box document to which the copy control information has been added, the copy control information is designed to be further combined for printing. Therefore, in a case of cancelling the box printing process itself in such a manner as not to doubly combine the copy control information, the process goes to step S1010. At step S1010, the box printing process is cancelled, and all the processes end (step S1011).

On the other hand, in a case of printing the box document without executing the combining process itself in such a manner as not to doubly combine the copy control information, the process goes to step S1007, and the following process continues to be executed.

As described above, according to the present embodiment, in a case where the scanned document is the document obtained by scanning the password document or the copy permission document and also the administrator setting of combining the copy control information with the scanned image is made, it can be prevented to doubly combine the copy control information. Further, occurrence of a state where the scanned document can not be printed can be prevented.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer, for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-251886, filed Nov. 17, 2011, which is hereby incorporated by reference herein in its entirety.

What is claimed is:

1. A printing apparatus capable of printing a scanned image stored therein, comprising:
a scanning unit configured to scan a document in response to an instruction by a user to store a scanned image;
a first determining unit configured to determine whether or not an administrator setting of combining a code image including password information with a scanned image is made;
a second determining unit configured to determine whether or not a code image including password information is included in a scanned image obtained through a scanning by the scanning unit; and
a notifying unit configured to, in a case where it is determined by the first determining unit that an administrator setting of combining a code image including password information with a scanned image is made and by the second determining unit that a code image including password information is included in a scanned image obtained through a scanning by the scanning unit, give a notice regarding the storing of the scanned image obtained through the scanning by the scanning unit to the user.

2. The printing apparatus according to claim 1, wherein the notifying unit notifies the user of not storing the scanned image obtained through the scanning by the scanning unit.

3. The printing apparatus according to claim 1, wherein the notifying unit notifies the user of eliminating the scanned image obtained through the scanning by the scanning unit.

4. The printing apparatus according to claim 1, wherein the notifying unit notifies the user that the scanned image obtained through the scanning by the scanning unit can be stored, but a stored scanned image can not be printed.

5. The printing apparatus according to claim 1, wherein the notifying unit provides an inquiry notice on whether to store the scanned image obtained through the scanning by the scanning unit.

6. A method executed by a printing apparatus capable of printing a scanned image stored therein, the method comprising the steps of:
scanning a document in response to an instruction by a user to store a scanned image;
first determining whether or not an administrator setting of combining a code image including password information with a scanned image is made;
second determining whether or not a code image including password information is included in a scanned image obtained through a scanning by the scanning step; and
notifying, in a case where it is determined by the first determining step that an administrator setting of combining a code image including password information with a scanned image is made and by the second determining step that a code image including password information is included in a scanned image obtained through a scanning by the scanning step, a notice regarding the storing of the scanned image obtained through the scanning by the scanning step to the user.

7. A program stored in a non-transitory computer readable storage medium for causing a computer to perform the method according to claim 6.
